(19) United States
(12) Patent Application Publication
(10) Pub. No.: US 2008/0091788 A1
(43) Pub. Date: Apr. 17, 2008

(54) CONTROLLER, ADDRESS CONTROL METHOD, AND DATA TRANSMISSION SYSTEM USING THE SAME

(75) Inventor: HUAI-YUAN FENG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,906

(22) Filed: Dec. 28, 2006

(30) Foreign Application Priority Data
Oct. 13, 2006 (CN) 200610063096.1

(51) Int. Cl. G06F 15/16

(52) U.S. Cl. 709/208

(57) ABSTRACT

A controller (10) for controlling a plurality of slave devices (111, 112) having a same address includes a plurality of pins (C₁₁, C₁₂), a determining module (103), a controller module (104), and a switching module (105). One of the pins transmits a first signal, and another of the pins transmits a second signal. The determining module determines which one of the slave devices is to be controlled according to a received control signal. The searching module controls the determined slave device. When needed, the switching module exchanges the first signal output from the one pin and the second signal output from the another pin according to the determined slave device.

### BACKGROUND OF THE INVENTION

1. Field of the Invention

The present invention relates to a controller, an address control method, and a data transmission system using the same.

2. Description of Related Art

Normally, an inter-integrated circuit bus (I²C bus) is a bridge between two or more ICs, which has two transmission lines to transmit signals. One is a serial data line (SDA), and the other one is a serial clock line (SCL). Due to comparatively high reliability and security, the I²C bus is widely used in electronic devices, especially between a microcontroller and a peripheral IC, or between ICs.

Generally, addresses of ICs communicating with each other via the I²C bus are predetermined during production. When the ICs (slave control component) having different addresses are connected to one I²C bus in parallel, a microcontroller (control component) communicates with different ICs according to their addresses. However, when two or more ICs have a same address, the microcontroller can't reliably distinguish between the two. Thus, the ICs are not efficiently controlled.

Conventionally, the ICs having the same address are controlled via different I²C buses connected thereto, or via a multiplexer connected between the microcontroller and the ICs. Therefore, a hardware resource of the microcontroller is occupied and cost thereof is relatively high.

### SUMMARY OF THE INVENTION

An exemplary embodiment of the present invention provides a controller for controlling a plurality of slave devices having a same address. The controller includes a plurality of pins, a determining module, a controller module, and a switching module. One of the pins transmits a first signal, and another of the pins transmits a second signal. The determining module determines which one of the slave devices is to be controlled according to received control signals. The searching module controls the determined slave device. If needed, the switching module exchanges the first signal output from the one pin and the second signal output from the another pin according to the determined slave device.

Another exemplary embodiment of the present invention provides a data transmission system. The data transmission system includes at least one group of slave devices having a same address and a controller. The controller is connected to the group of slave devices, for controlling the group of slave devices. The controller includes a plurality of pins, a determining module, a controller module, and a switching module. One of the pins transmits a first signal, and another of the pins transmits a second signal. The determining module determines which one of the slave devices is to be controlled according to received control signals. The searching module controls the determined slave device. If needed, the switching module exchanges the first signal output from the one pin and the second signal output from the another pin according to the determined slayer devices.

Another exemplary embodiment of the present invention provides an address control method for controlling a plurality of groups of slave devices. Each group of slave devices includes a first slave device and a second slave device. The address control method includes receiving control signals; determining whether the first slave device is to be controlled according to the control signals; exchanging outputs of two pins connected to the second slave device, if the first slave device is not to be controlled; and transmitting exchanged outputs to the second slave device.

Other advantages and novel features will become more apparent from the following detailed description when taken in conjunction with the accompanying drawings, in which:

### BRIEF DESCRIPTION OF THE DRAWINGS

FIG. 1 is a block diagram of a data transmission system of an exemplary embodiment of the present invention;

FIG. 2 is a block diagram of a data transmission system of another exemplary embodiment of the present invention;

FIG. 3 is a block diagram of a data transmission system of yet another exemplary embodiment of the present invention;

FIG. 4 is a block diagram of a data transmission system of yet another exemplary embodiment of the present invention;

FIG. 5 is a sketch map of a comparison table indicating groups and pins of an exemplary embodiment;

FIG. 6 is a flow chart of address controlling method of FIG. 1 of present invention; and

FIG. 7 is a flow chart of address controlling method of FIG. 3 of present invention.

### DETAILED DESCRIPTION OF THE INVENTION

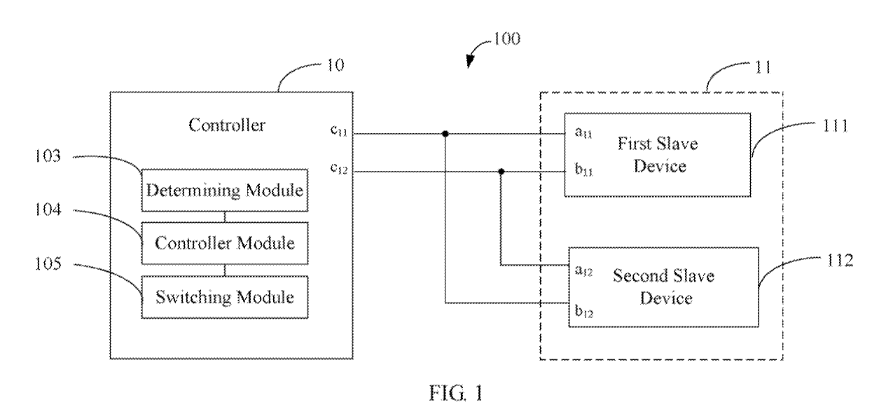

FIG. 1 is a block diagram of a data transmission system 100 of an exemplary embodiment of the present invention. In the exemplary embodiment, the data transmission system 100 includes a controller 10 and a group of slave devices 11. The controller 10, which has a first pin C₁₁ and a second pin C₁₂, includes a determining module 103, a controller module 104, and a switching module 105. The group of slave devices 11 includes a first slave device 111 and a second slave device 112. The first slave device 111 has a first data pin a₁₁ and a first clock pin b₁₁. Similarly, the second slave device 112 has a first data pin a₁₂ and a second clock pin b₁₂. In the exemplary embodiment, the first pin C₁₁ of the controller 10 transmits a first signal, such as: a data signal. The second pin C₁₂ of the controller 10 transmits a second signal, such as: a clock signal.

In the exemplary embodiment, the controller 10 is connected to the first slave device 111 and the second slave device 112 of the group of slave devices 11. The first data pin a₁₁ of the first slave device 111 is connected to the first pin C₁₁ of the controller 10, for receiving the data signals transmitted by the controller 10. The first data pin b₁₁ of the first slave device 111 is connected to the second pin C₁₂ of the controller 10, for receiving the clock signals transmitted by the controller 10. The second data pin a₁₂ of the second slave device 112 is connected to the second pin C₁₂ of the controller 10, for receiving the data signals transmitted by the controller 10. The second clock pin b₁₂ of the second slave device 112 is connected to the first pin C₁₁ of the controller 10, for receiving the clock signals transmitted by the controller 10. In the exemplary embodiment, the data signals are transmitted in a frame format, which contains address information of the slave devices 111, 112.

In the controller 10, the determining module 103 determines which one of the slave devices (111 or 112) is controlled according to received control signals. The controller module 104 controls the slave device determined by the determining module 103. If needed, the switching module 105 exchanges outputs of the first pin C₁₁ and the second pin C₁₂ of the controller 10. In the exemplary embodiment, if the controller 10 controls the first slave device 111, the switching module 105 dose not operate; if the controller 10 controls the second slave device 112, the switching module 105 exchanges outputs of the first pin C₁₁ and the second pin C₁₂, that is, the first pin C₁₁ of the controller 10 outputs the clock signal, and the second pin C₁₂ outputs the data signal. In the exemplary embodiment, the controller module 104 controls the slave devices 111, 112 via the clock signals and data signals, or the exchanged clock signals and data signals transmitted from the first pin C₁₁ and the second pin C₁₂ of the controller 10.

Generally, the controller 10 controls the slave devices, for such functions as: read and write, via a serial data line (SDA) and a serial clock line (SCL) of the I²C bus. The data signal transmitted in the I²C bus includes a start field, an address field, a read/write field, a body data field, an acknowledge field, and a stop field. Normally, only if the SDA is a logic low level, can the SCL be changed, allowing status of the slave device to be changed from read to write, or from write to read.

When the controller 10 controls the first slave device 111, the first pin C₁₁ of the controller 10 outputs data signals to the first data pin a₁₁ of the first slave device 111, and the second pin C₁₂ of the controller 10 outputs clock signals to the first clock pin b₁₁ of the first slave device 111. Connected to the first data pin a₁₁ of the first slave device 111 is the SDA, and connected to the first clock pin b₁₁ of the first slave device 111 is the SCL.

In detail, when the SCL is at the logic high level and the SDA is changed from the logic high level to the logic low level, the controller 10 starts to control the slave devices 111 or 112. In the exemplary embodiment, the first slave device 111 and the second slave device 112 have the same address. In addition, the first and the second data pins a₁₁ and a₁₂ receive the data signals output from the controller 10, and the first and the second clock pins b₁₁ and b₁₂ receive the clock signals output from the controller 10. Further, connections between the first slave device 111 and the controller 10 are opposite to those of the second slave device 112 and the controller 10. Therefore, when the outputs of the first pin C₁₁ and the second pin C₁₂ are not exchanged, only the first slave device 111, can exactly match the address contained in the data signal, and then can be controlled by the controller 10. Consequently, the first slave device 111 acknowledges to the controller 10. Contrarily, the second slave device 112 can't match the address contained in the data signal, thus, does not operate. In the data signals, the logic high level indicates to read, and the logic low level indicates to write.

When the first slave device 111 acknowledges to the controller 10, the controller 10 transmits the body data to the first slave device 111. Then, the first slave device 111 again acknowledges to the controller 10 after receiving the body data. In the exemplary embodiment, the controller 10 transmits a byte (8 bits) each time, and the first slave device 111 acknowledges to the controller 10. If the controller 10 stops transmitting the body data, the SDA is changed from the logic low level to the logic high level, and the SCL is still at the logic high level, and transmission is stopped.

In the exemplary embodiment, the address and the read/write information contained in the data signal are only transmitted from the controller 10 to the first slave device 111, however, the body data information contained in the data signal can be transmitted from the first slave device 111 to the controller 10, or from the controller 10 to the first slave device 111. That is, when the controller 10 receives a control signal for writing, the controller 10 enters a transmission mode and the first slave device 111 enters a receiving mode. When the controller 10 receives a control signal for reading, the controller 10 enters the receiving mode and the first slave device 111 enters the transmission mode.

If the controller 10 controls the second slave device 112, the outputs of the first pin C₁₁ and the second pin C₁₂ are exchanged, that is, the clock signal is transmitted to the second clock pin b₁₂ of the second slave device 112 via the first pin C₁₁ of the controller 10, and the data signal is transmitted to the second data pin a₁₂ of the second slave device 112 via the second pin C₁₂ of the controller 10. In this circumstance, connected to the second data pin a₁₂ of the second slave device 112 is the SDA, and connected to the second clock pin b₁₂ of the slave second device 112 is the SCL. Therefore, only the second slave device 112 exactly matches the address and the read/write information contained in the data signal, and acknowledges to the controller 10. Contrarily, the first slave device 111 does not operate.

In the exemplary embodiment, connections between the controller 10 and the first slave device 111 are defined as a positive connection, and connections between the controller 10 and the second slave device 112 are defined as a negative connection. Obviously, the first slave device 111 and the second slave device 112 have opposite connections. Therefore, when the first pin C₁₁ of the controller 10 outputs data signals, and the second pin C₁₂ thereof outputs clock signals, the controller 10 can only control the first slave device 111. However, when the switching module 104 changes outputs of the first pin C₁₁ and the second pin C₁₂ of the controller 10, that is, the first pin C₁₁ of the controller 10 outputs the clock signal and the second pin C₁₂ thereof outputs the data signal, the controller 10 can only control the second slave device 112 even though the second slave device 112 has the same address as the first slave device 111.

Therefore, by changing the connections between the controller 10 and the first and second slave devices 111, 112 only one I²C bus is needed for controlling them both.

In the exemplary embodiment, the controller 10 can be a microcontroller. The first slave device 111 and the second slave device 112 can be small form-factor pluggable (SFP) lighting modules, temperature sensors, EPROMs, or so on.

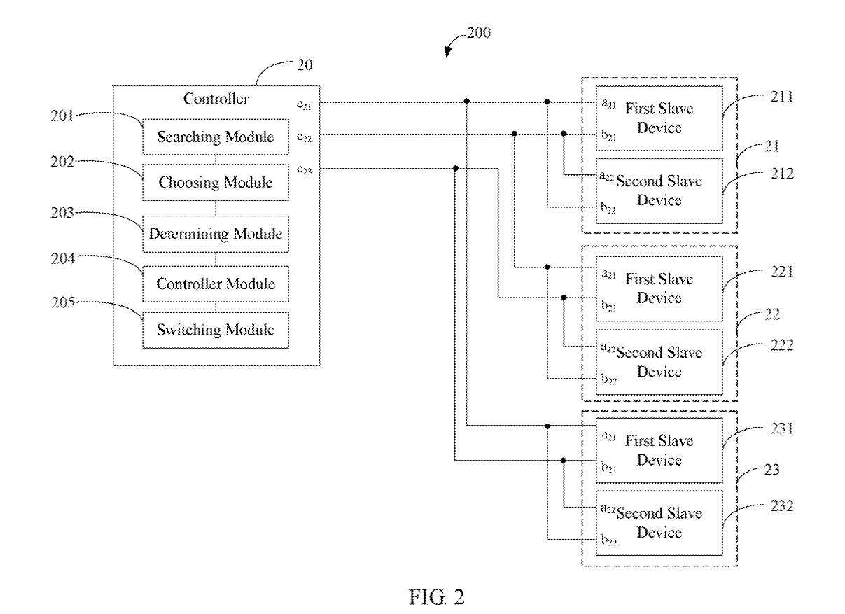

FIG. 2 is a block diagram of a data transmission system 200 of another exemplary embodiment of the present invention. In the exemplary embodiment, the data transmission system 200 is substantially the same as that of the data transmission system 100, except that a controller 20 controls three groups of slave devices 21, 22, 23 in the data transmission system 200. In addition, the controller 20 has a third pin C₂₃ also for transmitting a first signal or a second signal. The controller 20 further includes a searching module 201 and a choosing module 202. In the exemplary embodiment, each group of the slave devices has same structure, which includes a first slave device with the positive connections and a second slave device with the negative connections.

In the exemplary embodiment, the searching module 201 finds the group of slave devices to be controlled according to a received control signaling. The choosing module 202 chooses two pins of the first pin C₂₁, the second pin C₂₂ and the third pin C₂₃ to transmit the clock signal and the data signal according to the group of slave devices to be controlled. In the exemplary embodiment, the first group of slave devices 21 is controlled via the first pin C₂₁ and the second pin C₂₂; the second group of slave devices 22 is controlled via the second pin C₂₂ and the third pin C₂₃; and the third group of slave devices 23 is controlled via the first pin C₂₁ and the third pin C₂₃.

In alternative embodiments, the first group of slave devices 21, the second group of slave devices 22, and the third group of slave devices 23 are controlled via other combination of pins, which are not limited above. Therefore, connections between the groups of slave devices 21, 22, 23 and the pins C₂₁, C₂₂, C₂₃ of the controller 20 are not limited to the connections shown in FIG. 2.

In the exemplary embodiment, the controller 20 can control six slave devices 211, 212, 221, 222, 231, and 232 having the same address, via different pins. The connections between the first group of slave devices 21 and the controller 20 are the same as those of FIG. 1, thus description can be omitted. The first data pin a₂₁ of the first slave device 221 of the second group of slave devices 22 is connected to the second pin C₂₂ of the controller 20, and the first clock pin b21 thereof is connected to the third pin C₂₃ of the controller 20. The second data pin a₂₂ of the second slave device 222 of the second group of slave devices 22 is connected to the third pin C₂₃ of the controller 20, and the second clock pin b₂₂ thereof is connected to the second pin C₂₂ of the controller 20. The first data pin a₂₁ of the first slave device 231 of the third group of slave devices 23 is connected to the first pin C₂₁ of the controller 20, and the first clock pin b₂₁ thereof is connected to the third pin C₂₃ of the controller 20. The second data pin a₂₂ of the second slave device 232 of the third group of slave devices 23 is connected to the third pin C₂₃ of the controller 20, and the second clock pin b₂₂ thereof is connected to the first pin C₂₁ of the controller 20.

The controller 20 controls the groups of slave devices 21, 22, 23 having the same address by transmitting the data signals and the clock signals via different pins thereof. In the exemplary embodiment, in the same group of slave devices, when the connections between the controller 20 and the first slave devices, or the controller 20 and the second slave devices are opposite, the clock signal and the data signal transmitted to the slave devices are also exchanged. Thus, the second slave devices 212, 222, 232 having the same addresses as the first slave devices 211, 221, 231 can be controlled via the exchanged clock signals and data signals, and the first slave devices 211, 221, 231 can be controlled by un-exchanged clock signals and data signals.

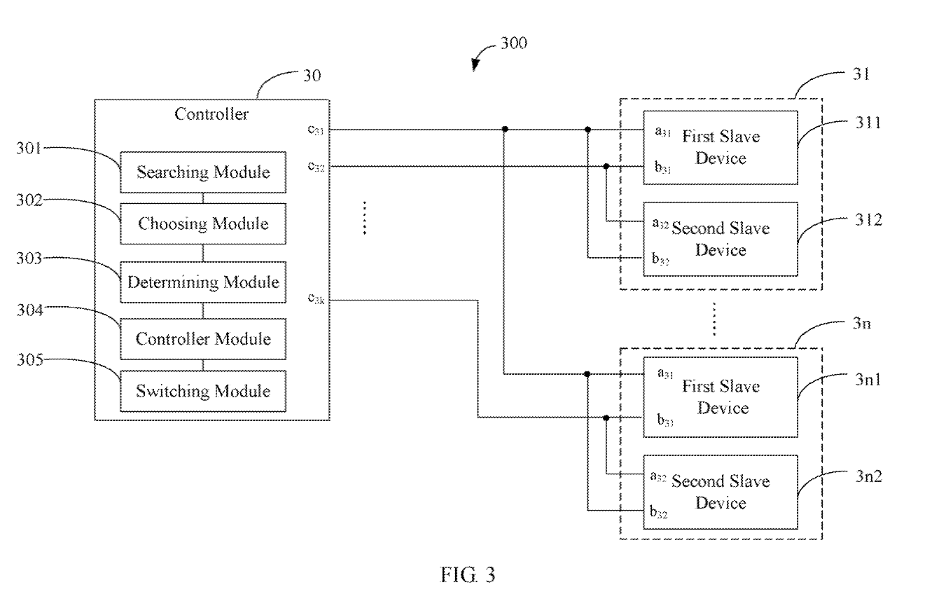

FIG. 3 is a block diagram of a data transmission system 300 of yet another exemplary embodiment of the present invention. The data transmission system 300 is substantially the same as that of the data transmission system 200 in FIG. 2, except that the controller 30 controls a plurality of groups of slave devices 3n (n=1, 2, 3, . . . , n). In addition, the controller 30 has a plurality of pins C₃ₖ (k=1, 2, 3, . . . , k).

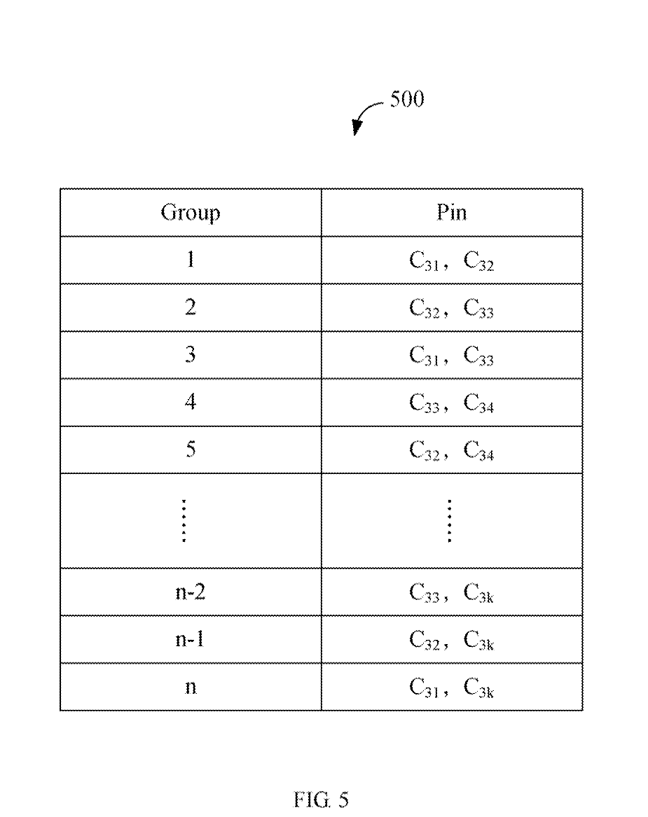

In the exemplary embodiment, the searching module 301 looks in a comparison table relating groups and pins (shown in FIG. 5) to find a group corresponding to one slave device. The choosing module 302 chooses two of the pins C₃ₖ (k=1, 2, 3, . . . , k) to transmit the clock signal and the data signal according to the table look-up. Similarly, relations between the groups corresponding to the slave devices and the pins (k=1, 2, 3, . . . , k) corresponding to the controller 30 are not limited to those of FIG. 5.

When the controller 30 is connected to the groups of slave devices 3n (n=1, 2, 3, . . . , n) based on the comparison table 500, the groups of slave devices 3n (n=1, 2, 3, . . . , n) having a same address can be controlled. The connections between the first group of slave devices 31 and the controller 30 are the same as those of FIG. 2, thus description can be omitted. In the exemplary embodiment, the first data pin a₃₁ of the first slave device 3n1 of the n^{th} group of slave devices 3n is connected to the first pin C₃₁ of the controller 30, and the first clock pin b₃₁ thereof is connected to the k^{th} pin C₃ₖ of the controller 30. The second data pin a32 of the second slave device 3n2 of the n^{th} group of slave devices 3n is connected to the k^{th} pin C₃ₖ of the controller 30, and the second clock pin b₃₂ thereof is connected to the first pin C₃₁ of the controller 30.

Similarly, the controller 30 controls different groups of slave devices 3n (n=1, 2, 3, . . . n) having the same address by transmitting data signals and clock signals via different pins thereof. In the exemplary embodiment, the controller 30 can control k×(k−1) slave devices. In the exemplary embodiment, k is an amount of pins of the controller 30.

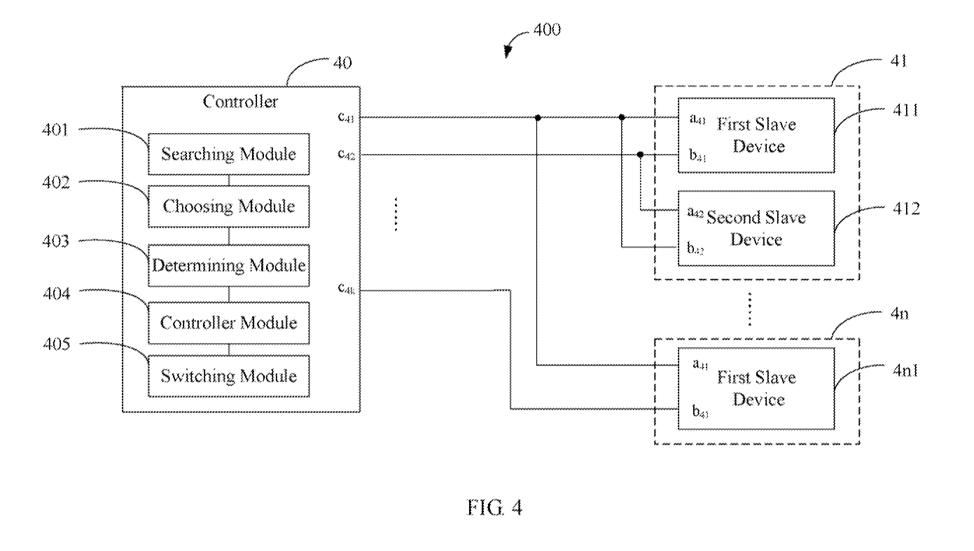

FIG. 4 is a block diagram of a data transmission system 400 of yet another exemplary embodiment of the present invention. The data transmission system 400 is substantially the same as that of the data transmission system 300 in FIG. 3, except that the n^{th} group of slave devices 4n only includes a first slave device 4n1. In alternative embodiments, the n^{th} group of slave devices 4n only includes a second slave device 4n2.

FIG. 5 is a sketch map of the comparison table 500 relating groups and pins of the present invention. The comparison table 500 includes a group field of slave devices and a pin field of the controller. In the exemplary embodiment, when the controller 30 receives control signals, the searching module 301 finds a group of slave devices to be controlled by looking in the comparison table 500. Then, the choosing module 302 chooses two pins of the controller 30 corresponding to the look-up.

In the exemplary embodiment, the comparison table 500 is set after hardware of the data transmission system is set up. That is, once the connections between the controller and the slave devices are made, users can set the relations between the groups and the pins in the comparison table 500.

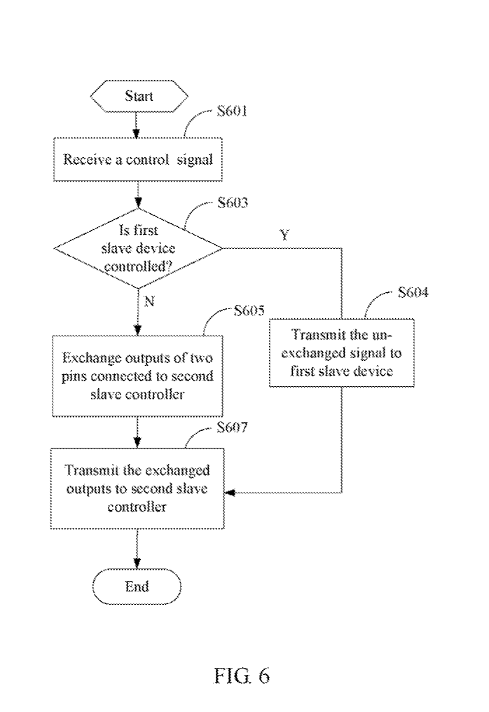

FIG. 6 is a flow chart of an address controlling method of FIG. 1 of the present invention. In step S601, the controller 10 receives control signals. In step S603, the determining module 103 determines whether the first slave device 111 is to be controlled according to a received control signals. If the first slave device 111 is not to be controlled, in step S605, the switching module 105 changes outputs of two pins connected to the second slave device 112. That is, the first pin C₁₁ outputs a clock signal, and the second pin C₁₂ outputs a data signal. In step S607, the controller module 104 transmits exchanged outputs to the second slave device 112. In step S604, if the first slave device 111 is to be controlled, the controller 10 transmits un-exchanged outputs to the first slave device 111. Thus, the first pin C11 outputs data signals, and the second pin C12 outputs clock signals.

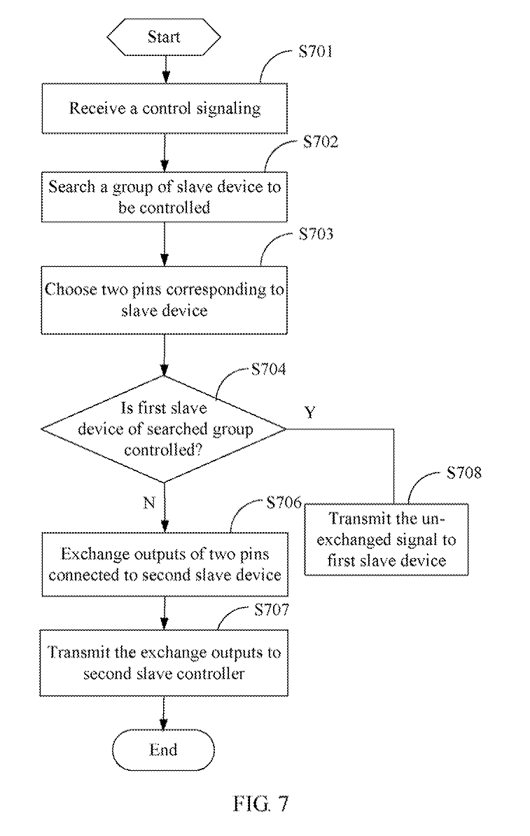

FIG. 7 is a flow chart of an address controlling method of FIG. 3 of the present invention. In step S701, the controller 30 receives control signals. In step S702, the searching module 301 finds a group of slave devices to be controlled in a comparison table 500 according to the received control signals. In step S703, the choosing module 302 chooses two pins of the controller 30 according to the group of slave devices found in the comparison table 500. For example, when the searching module 301 finds the n^{th} group of slave devices to be controlled, the choosing module 302 chooses the first pin C₃₁ and the second pin C₃ₖ according to the table 500.

In step S704, the determining module 303 determines whether the first slave device of the found group is to be controlled. If the first slave device is not to be controlled, in step S706, the switching module 305 exchanges outputs of the two pins connected to a second slave device of the found group. For example, the first pin C₃₁ outputs the clock signal, and the k^{th} pin C₃ₖ outputs the data signal. In step S707, the controller module 304 transmits the exchanged outputs to the second slave device. In step S708, if the first slave device is to be controlled, the controller module 304 transmits the un-exchanged outputs to the first slave device. Thus, the first pin C₃₁ outputs data signals, and the k^{th} pin C₃ₖ outputs clock signals.

In the exemplary embodiment, a method for controlling a plurality of slave devices 4n (n=1, 2, 3, . . . , n) by the controller 40 is the same as that of FIG. 7, thus description is omitted.

In the present invention, a plurality of slave devices having the same address are controlled via one I²C bus due to exchange of outputs of pins connected thereto when needed, which is simple and cost effective.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalent.

What is claimed is:

1. A controller for controlling a plurality of slave devices having the same address, the controller comprises:
a plurality of pins; wherein one of the pins transmits a first signal, and another one of the pins transmits a second signal;
a determining module for determining which one of the slave devices is to be controlled according to a received control signal;
a controller module for controlling the determined slave device; and
a switching module for exchanging the outputs of the one pin and the another pin when needed, according to the determined slave device.

2. The controller as claimed in claim 1, further comprising a searching module for finding a group of the determined slave devices according to the received control signal.

3. The controller as claimed in claim 2, further comprising a choosing module for choosing two of the plurality of pins to transmit the first signal and the second signal according to the found group.

4. The controller as claimed in claim 1, wherein the first signal is a data signal, and the second signal is a clock signal.

5. An address control method for controlling a plurality of groups of slave devices, and each group of slave devices comprising a first slave device and a second slave device, the address control method comprising:
receiving a control signal;
determining whether the first slave device is to be controlled according to the control signal;
exchanging outputs of two pins connected to the second slave device, if the first slave device is not to be controlled; and
transmitting exchanged outputs to the second slave device.

6. The address control method as claimed in claim 5, further comprising a step of finding a group of the slave devices to be controlled according to the received control signal.

7. The address control method as claimed in claim 6, further comprising a step of choosing two of the plurality of pins according to the found group.

8. The address control method as claimed in claim 5, wherein the step of determining whether the first slave device is to be controlled comprising transmitting un-exchanged output to the first slave device, if the first slave device is to be controlled.

9. A data transmission system comprising:
at least one group of slave devices having a same address; and
a controller connected to the at least one group of slave devices, for controlling the at least one group of slave devices, comprising:
a plurality of pins; wherein one of the pins transmits a first signal, and another one of the pins transmits a second signal;
a determining module for determining which slave device of the at least one group of slave devices is to be controlled according to a received control signal;
a controller module for controlling the determined slave device; and
a switching module for exchanging outputs of the one pin and the another pin when needed, according to the determined slave device.

10. The data transmission system as claimed in claim 9, further comprising a searching module for finding the determined slave device according to the received control signal.

11. The data transmission system as claimed in claim 10, further comprising a choosing module for choosing two of the plurality of pins to transmit the first signal and the second signal according to the determined slave device.

12. The data transmission system as claimed in claim 1, wherein an amount of the at least one group of slave devices is n, and n is an integer, and each group of slave devices comprising a first slave device and a second slave device.

13. The data transmission system as claimed in claim 12, wherein each of the first slave devices comprises:
a data pin connected to one of the plurality of pins, for receiving a data signal output from the controller; and
a clock signal pin connected to another one of the plurality of pins, for receiving a clock signal output from the controller.

14. The data transmission system as claimed in claim 13, wherein each of the second slave devices comprises:
a data pin connected to the another one of the plurality of pins, for receiving a data signal output from the controller; and
a clock signal pin connected to the one of the plurality of pins, for receiving a clock signal output from the controller.

15. The data transmission system as claimed in claim 11, wherein an amount of the at least one group of slave devices is n, and n is an integer, and each group of slave devices comprising at least one slave device.

16. The data transmission system as claimed in claim 15, wherein each of the one slave device comprises:
a data pin connected to one of the plurality of pins, for receiving a data signal output from the controller; and
a clock signal pin connected to another one of the plurality of pins, for receiving a clock signal output from the controller.

17. The data transmission system as claimed in claim 9, wherein the first signal is a data signal, and the second signal is a clock signal.
